(19) United States
(12) Patent Application Publication
(10) Pub. No.: US 2012/0123894 A1
(43) Pub. Date: May 17, 2012

(54) Decentralized Transportation Dispatching System and Method for Decentralized Transportation Dispatching

(75) Inventors: Frank Chee-Da Tsai, Taipei City (TW); Anthony Chou, New Taipei City (TW); Wen-Yao Chang, New Taipei City (TW)

(73) Assignee: INSTITUTE FOR INFORMATION INDUSTRY, Taipei (TW)

(21) Appl. No.: 13/295,198

(22) Filed: Nov. 14, 2011

(30) Foreign Application Priority Data
Nov. 17, 2010 (TW) 099139541

(51) Int. Cl. G06Q 50/30; G06Q 30/06

(52) U.S. Cl. 705/26.4

(57) ABSTRACT

A method for decentralized transportation dispatching is disclosed. The method bypasses utilizing a centralized dispatch call center and includes announcing a transportation requirement via broadcasting directly by at least one user, and replying to the transportation requirement with a plurality of competitive bidding information directly from a plurality of transportation providers who are capable of providing a passenger-carrying service or providing a goods-carrying service. The method further includes selecting one transportation provider from the transportation providers according to a request from the user, in which the selecting is performed through referencing the bidding information replied to by the transportation providers.

### RELATED APPLICATIONS

This application claims priority to Taiwan Patent Application Serial Number 099139541, filed Nov. 17, 2010, which is herein incorporated by reference.

### BACKGROUND

1. Field of Invention

The present invention relates to an automatic dispatching method. More particularly, the present invention relates to an automatic vehicle dispatching method.

2. Description of Related Art

In traditional transport dispatching system, the car dispatching service provided by a vehicle fleet company (for example, a taxi cab company) enables passengers to call vehicles by phone or network. After receiving a car dispatch request, an employee (call center staff) at a dispatching center (e.g., an operator) contacts all the vehicle drivers through radio communication. The employee at the dispatching center notify (mostly via Cellular communications systems) drivers around the passenger's location and asks if any of the vehicle drivers can arrive at the passenger's location on time. The vehicle drivers check if they can arrive at the passenger's location on time and inform the dispatching center if they are willing to carry the passenger. The employee at the dispatching center chooses one of the vehicle drivers to carry the passenger accordingly.

Such a business model is in line with traditional procurement models. That is, with this kind of business model, a number of business entities make their services and contact information known, and a person in charge of purchases selects one of the business entities according to various factors, such as the service provided by the particular business entity. However, such a “centralized” dispatching center involves procedures that are time-consuming for the operator. Moreover, the fairness of the selection process may be challenged. And it's necessary for the dispatch call center to maintain appropriate service level, and the laborious call center counts for a big share of vehicle fleet company's operating cost.

In such a conventional client/server dispatching method, the drivers of the vehicles participating in the system run by the dispatching center need to continually report their present locations to the dispatching center through costly Cellular communications, no matter if they carry passengers or not. The only way employees (i.e., operators) at the dispatching center could find the vehicle situation is by the information replies from the vehicle drivers.

Furthermore, if passengers are not at their home, they usually request vehicle dispatching by their mobile phones, which will increase expenses for such passengers. In addition, if the chosen vehicle fleet company has to send vehicle from a far area, cost is increased for the driver of the vehicle due to the gas used during the long drive, and pollution will be made at the same time.

Therefore, there is a need for a new vehicle dispatching method which can improve dispatching efficiency, reduce cost for both of the vehicle fleet company and the passengers, and may mitigate emission pollution impact to the environment as well.

### SUMMARY

The present invention is related to a decentralized transportation dispatching method and system thereof. It differs from traditional dispatching systems using a centralized call center, which can be a bottleneck for both time and cost. Rather, it makes each passenger to play the role of a call center, utilizing broadcasting communication technologies to notify surrounding drivers of the passenger's service request. And let the drivers respond to the passenger directly. Such decentralized way is unlike that in traditional dispatching systems where all passengers go through the centralized dispatch call center to request service and all drives respond also through the centralized dispatch call center.

According to one embodiment of the present invention, a method for decentralized transportation dispatching is disclosed. The method includes announcing a transportation requirement via broadcasting by at least one user, and replying to the transportation requirement with a plurality of competitive bidding information from a plurality of transportation providers who are willing and capable of providing a passenger-carrying service or providing a goods-carrying service. The method further includes selecting one transportation provider from the transportation providers according to at least one request from the user, wherein the selecting is performed through referencing the bidding information replied to by the transportation providers.

According to another embodiment of the present invention, a method for decentralized transportation dispatching is disclosed. The method includes the following procedures: receiving a calling signal from a user; in response to receiving the calling signal, sending a regional communication signal which initiates generation of at least one regional reply signal by the driver of at least one vehicle; waiting for the regional reply signal; storing the regional reply signal; when only one regional reply signal exists, giving priority to the only one regional reply signal; when there are several regional reply signals, sorting the regional reply signals and giving priority to one of the sorted regional reply signals; and dispatching the vehicle corresponding to the regional reply signal having priority to carry the user or goods.

According to still another embodiment of the present invention, a method for decentralized transportation dispatching is disclosed. The method includes receiving a regional communication signal, determining whether a vehicle driver is willing to carry passengers after receiving the regional communication signal, replies with a regional reply signal when the willingness by the vehicle driver to carry passengers is affirmed, waiting for a dispatching signal, and sends an affirming message that affirms the vehicle driver will puck up the passenger in response to receiving the dispatching signal.

According to the other embodiment of the present invention, a decentralized transportation dispatching system is disclosed. The decentralized transportation dispatching system dispatches at least one vehicle according to a calling signal from a user, and comprises a user interface. The user interface, in turn, comprises a fixed terminal regional signal transmitter, a fixed terminal regional signal receiver, a memory unit, a sorting control unit, and a calling unit. The fixed terminal regional signal transmitter transmits a regional communication signal according to the calling signal inputted by a user. The fixed terminal regional signal receiver receives at least one regional reply signal from at least one vehicle, in which the regional reply signal is initiated by the regional communication signal. The memory unit stores the at least one regional reply signal. The sorting control unit, when there are several regional reply signals, sorts the regional reply signals to give priority to one of the regional reply signals. The calling unit controls the fixed terminal regional signal transmitter for dispatching the vehicle to carry the user, according to the regional reply signal having priority.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a logical block diagram depicting a decentralized transportation dispatching system according to one embodiment of the present invention;

FIG. 2 is a flowchart of a method for decentralized transportation dispatching according to one embodiment of the present invention;

FIG. 3 is a flowchart of a method for decentralized transportation dispatching according to one embodiment of the present invention;

FIG. 4 is a flowchart of a method for decentralized transportation dispatching according to one embodiment of the present invention; and

FIG. 5 is a flowchart of a business method for decentralized transportation dispatching according to one embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The decentralized transportation dispatching system and method for decentralized transportation dispatching of the following embodiment mainly employ local-area (regional) communication technologies used in commercial telecommunications or ISM (Industry, Science and Medicine) communications, which broadcast calling signals to a vehicle in the vicinity of a user. The vehicle can merely employ a receiver and the driver of the vehicle does not need to join a specific vehicle fleet company to receive service requests. Through the transceiver utilizing local-area (regional) communication technologies, only the vehicles near the user can receive the calling message. As a result, the appropriate vehicle can be dispatched according to the location of the user, which increases the dispatching efficiency and reduces fuel consumption resulting from dispatching taxis at a significant distance from the passenger.

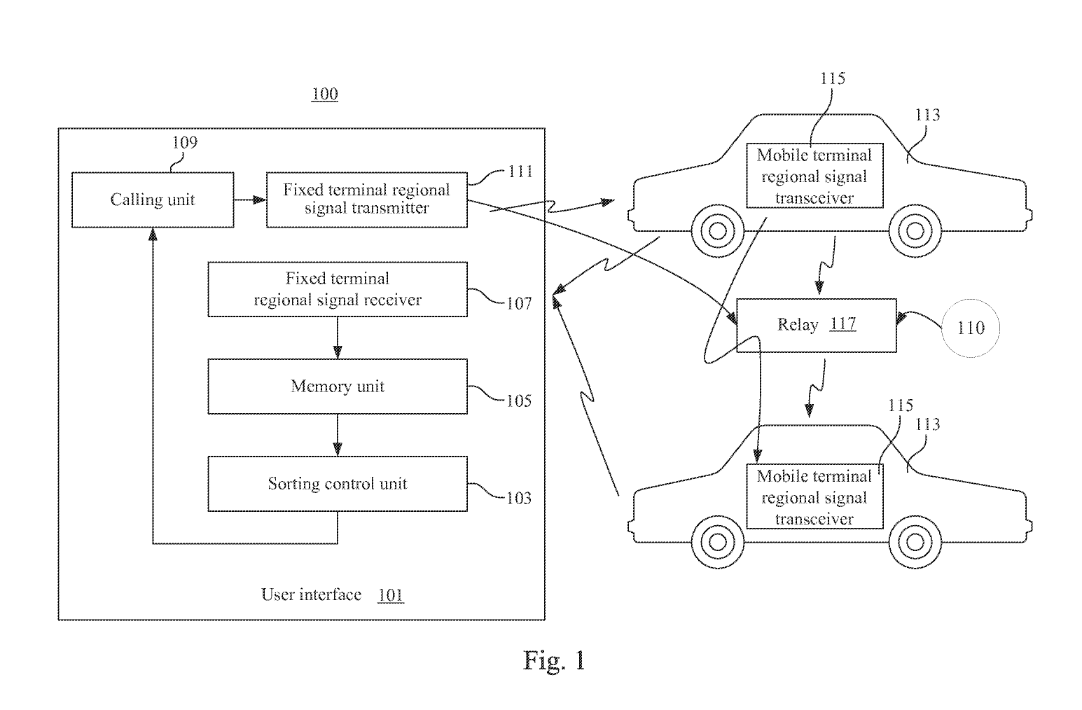

FIG. 1 is a logical block diagram depicting a decentralized transportation dispatching system according to one embodiment of the present invention. The decentralized transportation dispatching system 100 employs a local user interface 101 to dispatch, in a decentralized manner, at least one vehicle for passenger transportation according to a calling signal from a user. For example, the local user interface 101 can dispatch a taxi 113 for passenger transportation. Therefore, centralized dispatching and the possibility of a central server from getting busy associated with the use of centralized dispatching may be avoided. The decentralized transportation dispatching system 100 includes the main element of the user interface 101 which can be provided by an organization other than a vehicle fleet company and can be disposed everywhere. For example, the government can install electronic bus stops, multimedia kiosks, two-way interactive digital signages, or proprietary taxi-calling kiosks, around the city. Alternatively, a user can use a smart phone. Calling buttons or touch panel on those gadgets, which are examples of system 101, may be pressed by a user to call vehicles.

The user interface 101 is a logical combination of a fixed terminal regional signal transmitter 111, a fixed terminal regional signal receiver 107, a memory unit 105, a calling unit 109, and a sorting control unit 103.

The fixed terminal regional signal transmitter 111 transmits a regional communication signal to call the taxi 113 according to the calling signal inputted by a user, in which information sent by the regional communication signal may include the user Id, the vehicle ID (e.g. license plate number), the user position, the user preference, the number of passengers, and an image of the user. The local-area (regional) communication signal can be a commercial telecommunications network type signal or an ISM (Industry, Science and Medicine) band type signal. For example, regional communication signal can be the industrial scientific and medical (ISM) band signal, a Wi-Fi signal, a dedicated short range communication (DSRC) signal, a digital enhanced cordless telecommunications (DECT) signal, or a walkie-talkie signal. These signals can be broadcasted and delivered within a short distance. In more detail, the transmission distance of a Wi-Fi signal is around 150 meters, a dedicated short range communication signal around 1 kilometer, a digital enhanced cordless telecommunications signal around 200 meters, and a walkie-talkie around 2 to 5 kilometers. Signals beyond these distances cannot be received.

Because regional communication signals transmitted by the fixed terminal regional signal transmitter 111 are short-distance signals, taxis that are in the vicinity of the user interface 101 can receive the calling signal. Taxis beyond such a range cannot receive the calling signal, and as a result, the area in which the taxis can be called is restricted. Therefore, the vehicles can be dispatched according to the present location of the passenger, which increases dispatching efficiency and limits fuel consumption resulting from calling taxis at a significant distance from the passenger.

When the driver of the taxi 113 indicates a desire to carry passengers by transmitting a regional reply signal, the regional reply signal is received by the fixed terminal regional signal receiver 107 and stored by the memory unit 105. If there are two or more regional reply signals, indicating that two or more taxis 113 are willing to carry passengers, the sorting control unit 103 sorts the regional reply signals to give priority to one of the regional reply signals.

In more detail, the sorting control unit 103 can sort the regional reply signals and choose one from the sorted regional reply signals sent by the taxis 113 according to a first in first out (FIFO) method, meaning that the taxi 113 which first replies gets the opportunity to carry the passengers. In another aspect, the sorting control unit 103 can sort the regional reply signals according to a pre-determined selection method for matching user preference to vehicle characteristics. For example, to comply with government carbon reduction policies, the taxi 113 which consumes less fuel and generates less carbon has priority to carry passengers. After the sorting process, the calling unit 109 controls the fixed terminal regional signal transmitter 111 according to the regional reply signal having priority to transmit the signal for dispatching the taxi to carry the user.

In addition to the user interface 101, the decentralized transportation dispatching system 100 further includes a relay 117 and a mobile terminal regional signal transceiver 115 installed in the taxi 113 to allow for receipt of the regional communication signal from the fixed terminal regional signal transmitter 111. The mobile terminal regional signal transceiver 115 sends the regional reply signal if the taxi driver is willing to carry the passenger. The signals transmitted/received by the mobile terminal regional signal transceiver 115 are compatible with the signals transmitted by the fixed terminal regional signal transmitter 111. These signals can be industrial, scientific and medical (ISM) band signals, Wi-Fi signals, dedicated short range communication (DSRC) signals, digital enhanced cordless telecommunications (DECT) signals, or walkie-talkie signals.

In addition to receiving the regional communication signal directly broadcasted by the fixed terminal regional signal transmitter 111, the mobile terminal regional signal transceiver 115 installed in the taxi 113 can also receive a regional communication signal from another taxi 113 or from a relay 117 which the mobile terminal regional signal transceiver 115 installed in another taxi 113 or the fixed terminal regional signal transmitter 111 can pass regional communication signals to.

The relay 117 is employed to further pass the regional communication signal. For example, if the regional communication signal is dedicated short range communication (DSRC) signal which passes signals within 1000 m, a relay 117 is required to pass the signal to a destination as far as 2000 m. The relay 117 can be a taxi 113, an electronic bus stop, a multimedia kiosk, a two-way interactive digital signage, a proprietary taxi-calling kiosk, or a user 110 with a smart phone.

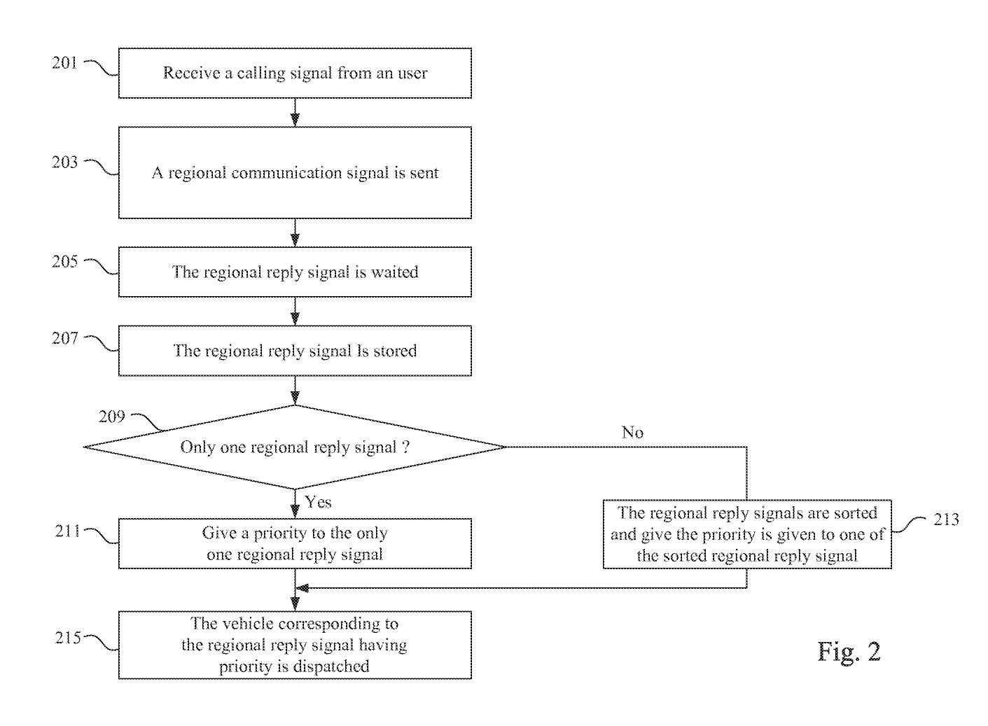

FIG. 2 is a flowchart of a method for decentralized transportation dispatching according to one embodiment of the present invention. The method includes receiving a calling signal from a user (step 201). Next, in response to receiving the calling signal, a regional communication signal is sent (step 203), and in response to receiving the regional communication signal, at least one regional reply signal is generated by the driver of a vehicle. Subsequently, the regional reply signal is waited for (step 205). The information included in the regional reply signal may include passenger capacity, license plate number of the vehicle, and other vehicle characteristics, such as whether the vehicle has high gas mileage or is an electrical vehicle. Similar to the regional communication signal, the regional reply signal can be a Wi-Fi signal, a dedicated short range communication signal (DSRC), a digital enhanced cordless telecommunications (DECT) signal, or a walkie-talkie signal. After receiving the regional reply signal, the regional reply signal is stored (step 207).

Next, a check is performed to determine if there is only one regional reply signal (step 209). If only one regional reply signal exists, priority is given to the only one regional reply signal (step 211). When there are several regional reply signals, the regional reply signals are sorted and priority is given to one of the sorted regional reply signals (step 213). Subsequently, the vehicle corresponding to the regional reply signal having priority is dispatched to carry the user or goods (step 215).

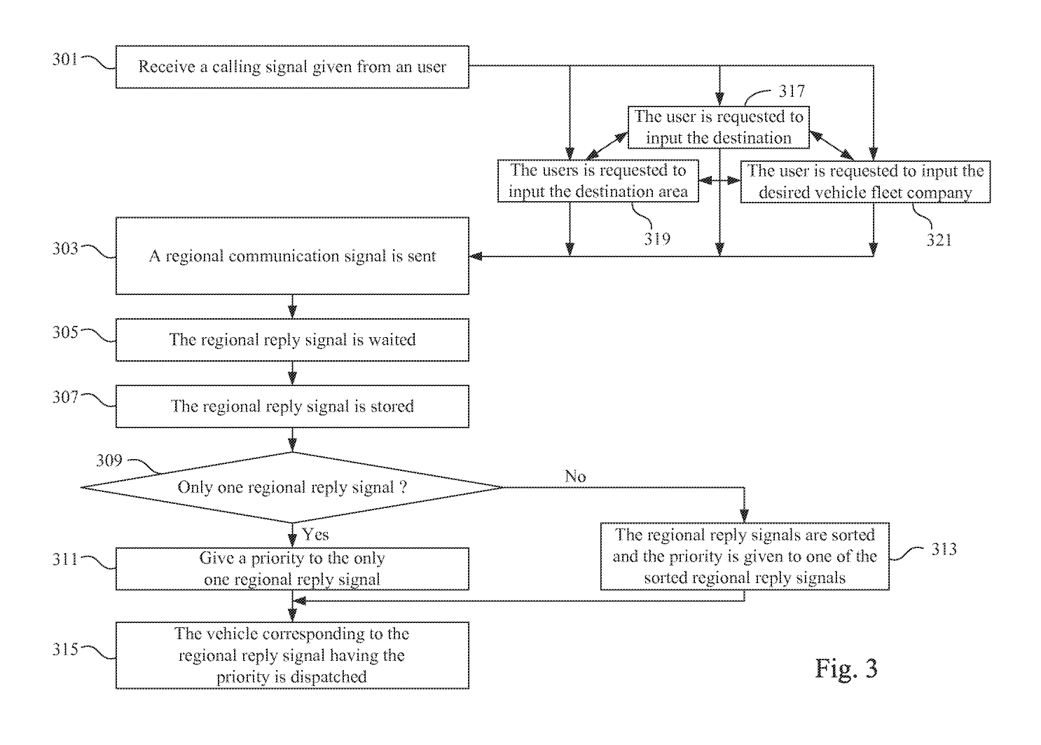

FIG. 3 is a flowchart of a method for decentralized transportation dispatching according to one embodiment of the present invention. In this embodiment, step 301 to step 315 are same as step 201 to step 215 in FIG. 2, while step 317, step 319, and step 321 are different. After receiving a calling signal from the user, the user is further requested to input a destination, such as Taipei railroad station, through a touch gesture or a voice command (step 317). Next, in step 319, the user is requested to input the destination area, and in step 321, the user is requested to input the desired vehicle fleet company, such as Taiwan Taxi. The sequence of performing step 317, step 319, and step 321 can be varied, or one of these steps can be skipped. After these steps, the method continues to step 303 to step 315, in which the information of steps 317 to 321 is included in the regional communication signal which is sent to dispatch the proper vehicle.

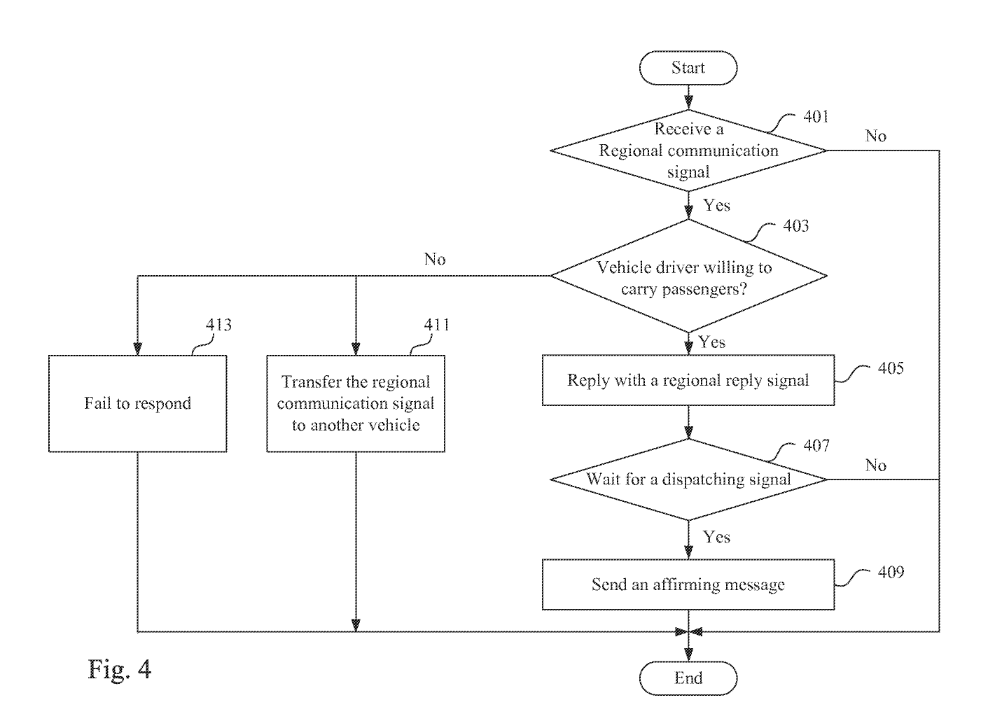

FIG. 4 is a flowchart of a method for decentralized transportation dispatching according to one embodiment of the present invention. The method shown in FIG. 4 is performed by the mobile terminal regional signal transceiver installed in the vehicle. The method includes receiving a regional communication signal (step 401) and determining whether the vehicle driver is willing to carry passengers after receiving the regional communication signal (step 403). When the willingness to carry passengers by the vehicle driver is affirmed, the method includes replying with a regional reply signal (step 405). Subsequently, the method includes waiting for a dispatching signal (step 407) and sending an affirming message that affirms the vehicle driver will pick up the passenger in response to receiving the dispatching signal (step 409). If the vehicle receives the regional communication signal but the vehicle driver is not willing to carry passengers in step 403, the vehicle can transfer the regional communication signal to another vehicle (step 411). Next, another vehicle can go to pick up the passengers. Alternatively, if the vehicle receives the regional communication signal but the vehicle driver is not willing to carry passengers in step 403, the vehicle driver can fail to respond (step 413).

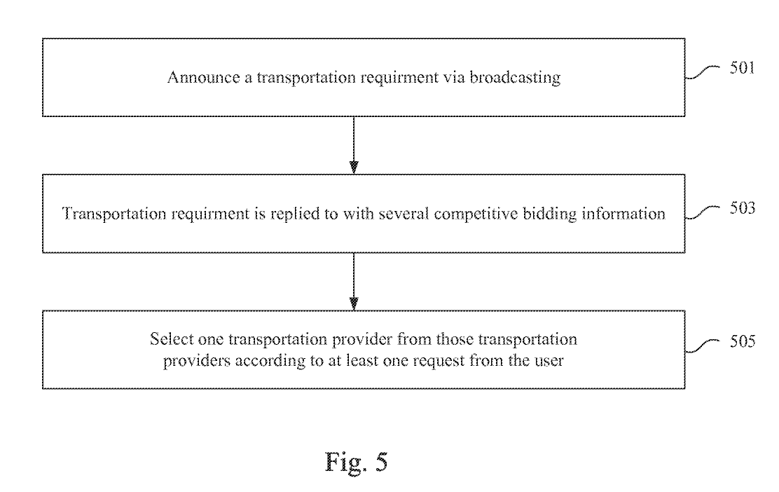

FIG. 5 is a flowchart of a business method for decentralized transportation dispatching according to one embodiment of the present invention. The method starts with announcing a transportation requirement via broadcasting by at least one user (step 501), after which the transportation requirement is replied to with several competitive bidding information from several transportation providers who are capable of providing a passenger-carrying service or providing a goods-carrying service (step 503). Next, the method includes selecting one transportation provider from the several transportation providers according to at least one request from the user (step 505), in which the selection is made through referencing the bidding information replied to by the transportation providers. In the method of this embodiment, the broadcasting is realized through radio broadcasting, and the transportation providers (for example, taxi agents) who have a radio broadcast receiver or a radio broadcast transmitter can be dispatched and reply to the transportation requirement. The transportation providers providing the competitive bidding information may belong to different vehicle fleet companies or may be self-employed.

The method for decentralized transportation dispatching and the decentralized transportation dispatching system of the above embodiments involve equipment and a platform that are provided by an organization other than a vehicle fleet company, and vehicles are dispatched in a decentralized manner in a manner that matches the vehicle to the user. Hence, a situation in which a centralized dispatch call center and fleet data server becomes busy due to centralized dispatching is avoided. Furthermore, the drivers of the vehicles do not need to join a particular vehicle fleet company, which reduces costs associated with taxi drivers.

In addition, the decentralized transportation dispatching system and method employ local-area (regional) communication technologies, which pass the calling signal only to vehicles in the vicinity of the user. As a result, vehicles can be dispatched inherently according to the location of the user, which increases the dispatching efficiency, and also minimizes fuel consumption caused by dispatching vehicles that are at a considerable distance away from the user.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for decentralized transportation dispatching, comprising:
announcing a transportation requirement via broadcasting by at least one user;
replying to the transportation requirement with a plurality of competitive bidding information from a plurality of transportation providers who are capable of providing a passenger-carrying service or providing a goods-carrying service; and
selecting one transportation provider from the transportation providers according to at least one request from the user, wherein the selecting is performed through referencing the bidding information replied to by the transportation providers.

2. The method for decentralized transportation dispatching as claimed in claim 1, wherein the broadcasting is realized through radio broadcasting, and the transportation providers who have a radio broadcast receiver or a radio broadcast transmitter can be dispatched and reply to the transportation requirement.

3. The method for decentralized transportation dispatching as claimed in claim 1, wherein the transportation providers providing the competitive bidding information can belong to different vehicle fleet companies.

4. The method for decentralized transportation dispatching as claimed in claim 1, wherein the transportation providers are self-employed.

5. The method for decentralized transportation dispatching as claimed in claim 1, wherein the transportation providers are taxi agents, motorcycle agents, delivery service providers, or mobile restaurant/snack service providers.

6. A method for decentralized transportation dispatching, comprising:
receiving a calling signal from a user;
in response to receiving the calling signal, sending a regional communication signal which initiates generation of at least one regional reply signal by the driver of at least one vehicle;
waiting for the regional reply signal;
storing the regional reply signal;
when only one regional reply signal exists, giving priority to the only one regional reply signal;
when there are several regional reply signals, sorting the regional reply signals and giving priority to one of the sorted regional reply signals; and
dispatching the vehicle corresponding to the regional reply signal having priority to carry the user or goods.

7. The method for decentralized transportation dispatching as claimed in claim 6, wherein each of the regional communication signal and the regional reply signal is a wireless fidelity (Wi-Fi) signal, a dedicated short range communication signal (DSRC), a digital enhanced cordless telecommunications (DECT) signal, or a walkie-talkie signal.

8. The method for decentralized transportation dispatching as claimed in claim 6, wherein the regional communication signal includes information of at least one of user Id, user position, use preference, number of passengers, and an image of the user.

9. The method for decentralized transportation dispatching as claimed in claim 8, wherein the regional communication signal is directly broadcasted to the vehicle or passed to the vehicle through a relay or another vehicle.

10. The method for decentralized transportation dispatching as claimed in claim 6, wherein the regional communication signal includes information of at least one of passenger capacity, vehicle id, and vehicle characteristics.

11. The method for decentralized transportation dispatching as claimed in claim 6, wherein the sorting is done according to a FIFO method or according to a pre-determined selection method for matching user preference to vehicle characteristics.

12. The method for decentralized transportation dispatching as claimed in claim 6, further comprising requesting the user to input a destination through a touch gesture or a voice command after receiving the calling signal.

13. The method for decentralized transportation dispatching as claimed in claim 6, further comprising requesting the user to input the desired vehicle fleet company through a touch gesture or a voice command after receiving the calling signal.

14. A method for decentralized transportation dispatching, comprising:
receiving a regional communication signal;
determining whether a vehicle driver is willing to carry passengers after receiving the regional communication signal;
replying with a regional reply signal when the willingness by the vehicle driver to carry passengers is affirmed;
waiting for a dispatching signal; and
sending an affirming message that affirms the vehicle driver will pick up the passenger in response to receiving the dispatching signal.

15. The method for decentralized transportation dispatching as claimed in claim 14, further comprising transferring the regional communication signal to another vehicle when the vehicle driver is not willing to carry passengers.

16. The method for decentralized transportation dispatching as claimed in claim 14, wherein the regional communication signal includes information of at least one of passenger capacity, vehicle id, and vehicle characteristics.

17. A decentralized transportation dispatching system for dispatching at least one vehicle according to a calling signal from a user, the decentralized transportation dispatching system comprising:
a user interface, comprising:
a fixed terminal regional signal transmitter for transmitting a regional communication signal according to the calling signal inputted by a user;
a fixed terminal regional signal receiver for receiving at least one regional reply signal from at least one vehicle, wherein the regional reply signal is initiated by the regional communication signal;
a memory unit for storing the at least one regional reply signal;
a sorting control unit which, when there are several regional reply signals, sorts the regional reply signals to give priority to one of the regional reply signals; and
a calling unit for controlling the fixed terminal regional signal transmitter according to the regional reply signal having priority for dispatching the vehicle to carry the user.

18. The decentralized transportation dispatching system as claimed in claim 17, wherein the user interface is installed in an electronic bus stop, a multimedia kiosk, a two-way interactive digital signage, a proprietary taxi-calling kiosk, or a user's mobile smart phone.

19. The decentralized transportation dispatching system as claimed in claim 17, further comprising a mobile terminal regional signal transceiver installed in the vehicle for receiving the regional communication signal and sending the regional reply signal.

20. The decentralized transportation dispatching system as claimed in claim 19, wherein the signal sent by the fixed terminal regional signal transmitter and the mobile terminal regional signal transceiver is a wireless fidelity (Wi-Fi) signal, a dedicated short range communication signal (DSCR), a personal handy-phone system signal, or a walkie-talkie signal.

21. The decentralized transportation dispatching system as claimed in claim 17, further comprising a relay for transmitting the regional signal to another vehicle, wherein the relay can be another electronic bus stop, another multimedia kiosk, another two-way interactive digital signage, another proprietary taxi-calling kiosk, or another user's mobile smart phone.

22. The decentralized transportation dispatching system as claimed in claim 17, wherein the sorting control unit sorts the regional reply signals according to a FIFO method or according to a pre-determined selection method for matching user preference to vehicle characteristics.
